(19) United States
(12) Patent Application Publication
(10) Pub. No.: US 2012/0048951 A1
(43) Pub. Date: Mar. 1, 2012

(54) Air Conditioning System for a Vehicle

(75) Inventors: Yong Chul KIM, Hwaseong-si (KR); Jae Sik CHOI, Suwan-si (KR)

(73) Assignees: KIA MOTORS CORPORATION, Seoul (KR); HYUNDAI MOTOR COMPANY, Seoul (KR)

(21) Appl. No.: 12/954,477

(22) Filed: Nov. 24, 2010

(30) Foreign Application Priority Data
Aug. 30, 2010 (KR) 10-2010-0084021

(51) Int. Cl. G05D 23/19

(52) U.S. Cl. 236/12.1

(57) ABSTRACT

An air conditioning system of a vehicle includes a body, an electric heater core installed within the body and configured to generate a hot air, a cooling device installed within the body and configured to generate a cold air, and a control device configured to control a temperature of the hot air generated by the electric heater core or a temperature of the cold air generated by the cooling device, respectively, by controlling an amount of current applied to the electric heater core or the cooling device according to a difference between an internal temperature or an external ambient temperature of the vehicle and a target temperature, the electric heater core and the cooling device being operated independently of each other.

### CROSS-REFERENCES TO RELATED APPLICATIONS

Priority claimed to Korean patent application number 10-2010-0084021, filed on Aug. 30, 2010, the entire contents of which application is incorporated herein for all purposes by this reference.

### BACKGROUND OF THE INVENTION

1. Field of the Invention

The present invention relates to an air conditioning system in which a heater and a cooler are independently operated to control a temperature within a vehicle.

2. Description of the Related Art

An air conditioning system of a vehicle controls temperature, humidity, air current, and air cleanliness of an internal space of the vehicle to achieve a desired condition.

FIG. 1 is a side sectional view illustrating a configuration of a conventional air conditioning system of a vehicle.

As shown in FIG. 1, a conventional air conditioning control system 1 equipped with an internal combustion engine such as gasoline/diesel engines includes an air conditioner body 100, a heater core 10 installed on a first side of the air conditioner body 100 to collect waste heat from the gasoline/diesel engines to generate a hot air, an evaporator 20 of an air conditioner installed on a second side of the air conditioner body 100 to generate a cold air, and a temperature control door D positioned between the heater core 10 and the evaporator 20 of the air conditioner body 100 to control an amount (or a ratio) of the cold air and the hot air. The air conditioning control system 1 also includes an inlet opening 102 through which an outside air is supplied and an outlet opening 104 through which an internal air in the body 100 is discharged from respective parts of the vehicle.

In the conventional air conditioning control system 1 of the vehicle, when heating or cooling the vehicle, both the heater core 10 and the evaporator 20 are operated and the hot air and the cold air respectively generated by the heater core 10 and the evaporator 20 are mixed at a predetermined ratio to control an internal temperature of the vehicle. The reason for mixing the cold air and the hot air at the predetermined ratio to control the temperature of the vehicle in the conventional air conditioning control system 1 of the vehicle is as follows. The heater core 10 and the evaporator 20 of the conventional air conditioning control system 1 do not have a function to control an intensity of blows of the cold air or the hot air, i.e., a temperature control function. For example, if a driver wants a cold air having a temperature of 25° C. (77° F.), the evaporator 20 cannot produce the cold air having the temperature of 25° C. (77° F.) but can merely produce the cold air of which temperature is fixed according to the specification, for example, 10° C. (50° F.). Therefore, in order to provide a desired temperature of the cold air (or the hot air), a certain amount of the hot air (or the cold air) should be mixed with the cold air (or the hot air). Such structure can be considered as optimal in terms of energy efficiency in a vehicle having the heater core 10 that employs the internal combustion engine to collect the waste heat of the engine. However, in an electric vehicle in which the waste heat does not exist, an electric heater (a positive temperature coefficient (PTC) heater) needs to be installed instead of the heater, which utilizes the waste heat. Moreover, in order to provide the cold air (or the hot air) having a user desired temperature in a conventional way, the electric heater core needs to be operated all the time, which causes waste of energy.

In addition, the conventional air conditioning system 1 of the vehicle needs to include all of the heater core 10, the evaporator 20 and the control door D. Therefore, it is difficult to miniaturize the conventional air conditioning system 1 of the vehicle.

Thus, there is a need to develop a technique to independently operate the heater core 10 and the evaporator without requiring the temperature control door D to precisely control temperatures of the hot air and the cold air generated by the heater core 10 and the evaporator 20, respectively.

The information disclosed in this Background section is only for enhancement of understanding of the general background of the invention and should not be taken as an acknowledgement or any form of suggestion that this information forms the prior art already known to a person skilled in the art.

### SUMMARY OF THE INVENTION

Various aspects of the present invention have been made in view of the above problems, and provides an air conditioning system of a vehicle, which independently operates a heater core and an evaporator without requiring a temperature control door to precisely control temperatures of a hot air and a cold air from the heater core and the evaporator.

According to an aspect of the present invention, an air conditioning system of a vehicle includes a body, an electric heater core installed within the body and configured to generate a hot air, a cooling device installed within the body and configured to generate a cold air, and a control device configured to control a temperature of the hot air generated by the electric heater core or a temperature of the cold air generated by the cooling device, respectively, by controlling an amount of current applied to the electric heater core or the cooling device according to a difference between an internal temperature or an external ambient temperature of the vehicle and a target temperature, the electric heater core and the cooling device being operated independently of each other.

The body may include an inlet opening positioned on a first side thereof through which an air is supplied from an external and a discharge opening positioned on a second side thereof through which the air supplied through the inlet opening is discharged to an internal space of the vehicle, wherein an inlet opening of the cooling device is positioned facing opposite to the inlet opening of the body, and wherein an inlet opening of the electric heater core is spaced apart from an outlet opening of the cooling device at a predetermined distance to be positioned facing opposite to the outlet opening of the cooling device, and wherein the cold air provided from the outlet opening of the cooling device passes through the inlet opening and an outlet opening of the electric heater core to be discharged from the discharge opening of the body.

The system may further include a first sensor configured to measure the internal temperature of the vehicle, a second sensor configured to measure the external ambient temperature of the vehicle, a key input unit configured to receive the target temperature, and a database configured to store the temperature of the hot air generated by the electric heater core according to each amount of the current or the temperature of the cold air generated by the cooling device according to the each amount of the current, wherein the control device turns to an air conditioning mode to independently operate the cooling device when the external ambient temperature or the internal temperature of the vehicle is higher than the target temperature, and wherein the control device turns to a heating mode to independently operate the heating device when the external ambient temperature or the internal temperature of the vehicle is lower than the target temperature.

The system may further include a third sensor configured to measure an intensity of sunlight irradiated into the vehicle, wherein the control device corrects the target temperature based on the intensity of the sunlight.

The control device may linearly control the amount of the current applied to the electric heater core or the cooling device using a pulse width modulation of a DC pulse wave.

The system may further include a fourth sensor configured to identify a ventilation mode of the vehicle, wherein, when the ventilation mode of the vehicle is an outer circulation mode, the external ambient temperature is compared with the target temperature to control the temperature of the hot air generated by the electric heater core or the temperature of the cold air generated by the cooling device and, when the ventilation mode is an internal circulation mode, the internal temperature is compared with the target temperature to control the temperature of the hot air generated by the electric heater core or the temperature of the cold air generated by the cooling device.

According to various aspects of the air conditioning system of the vehicle of the present invention, the temperature of the hot air generated by the electric heater core or the temperature of the cold air generated by the cooling device are controlled by controlling the amount of current applied to the electric heater core or the cooling device according to the difference between the internal temperature or the external ambient temperature of the vehicle and the target temperature, the electric heater core and the cooling device being operated independently of each other. In other words, the hot air or the cold air having a specific temperature is not generated by mixing the hot air and the cold air as in the conventional air conditioning system. In the present invention, either the heater core or the cooling device is independently operated to directly generate the hot air or the cold air having the specific temperature. Thus, the present invention may avoid energy waste compared to the conventional air conditioning system, which operates both the electric heater core and the cooling device to mix the hot air and the cold air. In addition, the present invention obviates a need for a temperature control door, which is included within a body of the conventional air conditioning system to mix the hot air and the cold air. Therefore, the air conditioning system according to the present invention may have reduced dimension and weight. Accordingly, the air conditioning system according to the present invention may be miniaturized, which contributes to reduction of a dimension and a weight of the vehicle.

In the air conditioning system of the vehicle according to the present invention, the electric heater core and the cooling device may be positioned side by side while being spaced apart from each other at a predetermined distance. In addition, in the air conditioning system of the vehicle according to the present invention, the cold air generated by the cooling device may be passed through the inlet opening and the outlet opening of the electric heater core to be discharged from the discharge opening of the body. Therefore, by displacing the electric heater core and the cooling device adjacent to each other, the air conditioning system of the vehicle may have a reduced dimension.

Further, the air conditioning system of the vehicle according to the present invention may include a database that stores the temperature of the hot air generated by the electric heater core according to each amount of the current or the temperature of the cold air generated by the cooling device according to the each amount of the current. Therefore, the present invention may precisely control the temperature of the hot air or the cold air according to the amount of the current, thereby enabling efficient management of the internal temperature of the vehicle.

Further, the air conditioning system of the vehicle according to the present invention may correct the target temperature set by the user based on the intensity of the sunlight. Thus, the present invention may control the internal temperature of the vehicle with consideration of the intensity of the sunlight and a user's sensible temperature.

Further, the air conditioning system of the vehicle according to the present invention may linearly control the amount of the current applied to the electric heater core or the cooling device using a pulse width modulation of a DC pulse wave. Therefore, the present invention may protect the electric heater core or the cooling device from an instantaneous excessive current. In addition, the present invention may obviate a need for a conventional mechanical relay having a current amount control function. Also, the present invention may achieve a reliable device operation by providing an average current level, while maximizing energy efficiency.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a side sectional view illustrating a configuration of a conventional air conditioning system of a vehicle.

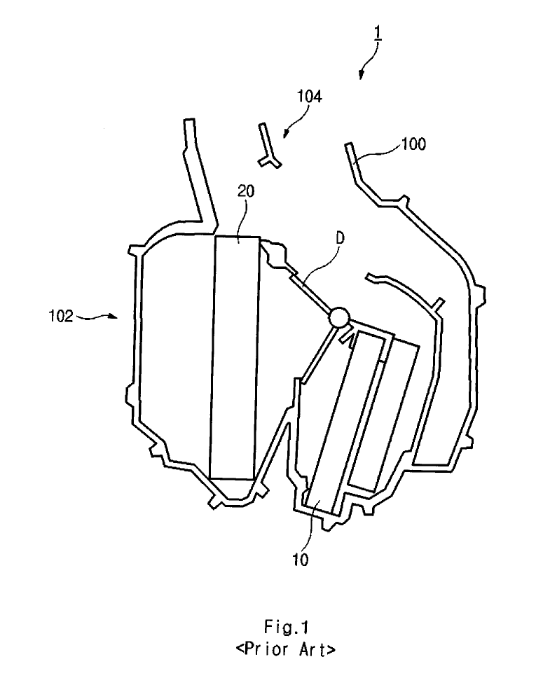

FIG. 2 is a block diagram illustrating a configuration of an exemplary air conditioning system of a vehicle according to the present invention.

FIG. 3 is a side sectional view illustrating a configuration of a body of an exemplary air conditioning system of a vehicle according to the present invention.

FIG. 4 is a perspective view illustrating an electric heater core of an exemplary air conditioning system of a vehicle according to the present invention.

FIG. 5 is a perspective view illustrating a cooling device of an exemplary air conditioning system of a vehicle according to the present invention.

FIG. 6 is a graph showing an exemplary method of determining a heating mode or a cooling mode by comparing a target temperature with an external ambient temperature/internal temperature in a control device of an air conditioning system of a vehicle of the present invention.

FIG. 7 is a graph showing an exemplary method of controlling an amount of a current to be supplied to an electric heater core or a cooling device through a duty rate control in a control device of an air conditioning system of a vehicle of the present invention.

FIG. 8 is a graph showing a temperature of a hot air generated by an exemplary electric heater core corresponding to a duty rate applied to the electric heater core according to the present invention, the duty rate varying depending on an external condition (external ambient temperature).

FIG. 9 is a flowchart illustrating an operation of an exemplary air conditioning system of a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

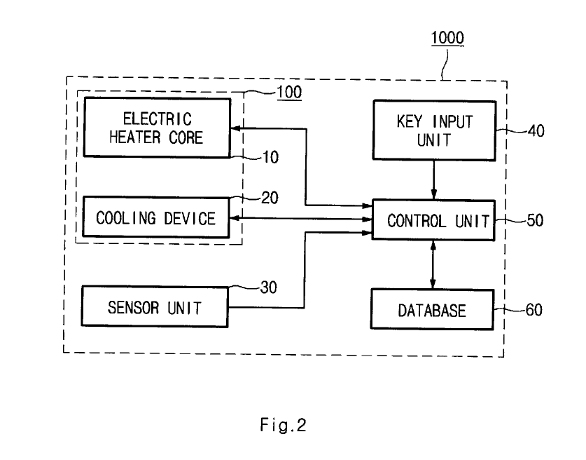

FIG. 2 is a block diagram illustrating a configuration of an air conditioning system 1000 of a vehicle according to the present invention.

As shown in FIG. 2, the air conditioning system 1000 of the vehicle according to the present invention includes a body 100, an electric heater core 10, a cooling device 20, a sensor 30, a key input unit 40, a control unit 50 and a database 60.

The body 100 is provided in a predetermined form and an external air flows in and out through a first side and a second side thereof, wherein the electric heater core 10 and the cooling device 20 are received within the body 100.

The electric heater core 10 is electrically operated and installed within the body 100 to generate a hot air of which temperature varies depending on an amount of current applied thereto by the control device 50.

The cooling device 20 is installed inside of the body 100 and generates a cold air of which temperature varies depending on the amount of the current applied thereto by the control device 50.

The sensor 30 measures an internal temperature, an external ambient temperature of the vehicle and an intensity of a sunlight and the key input unit 40 receives a target internal temperature of the vehicle.

According to a difference between the internal temperature or the external ambient temperature of the vehicle and the target temperature, the control unit 50 independently operates the electric heater core 10 or the cooling device 20. The control unit 50 controls a temperature of the hot air or a temperature of the cold air by controlling the amount of the current applied to the electric heater core 10 or air-conditioning unit 20.

Components of the air conditioning system 1000 of the vehicle according to the present invention are described below.

### Configuration of the Body 100

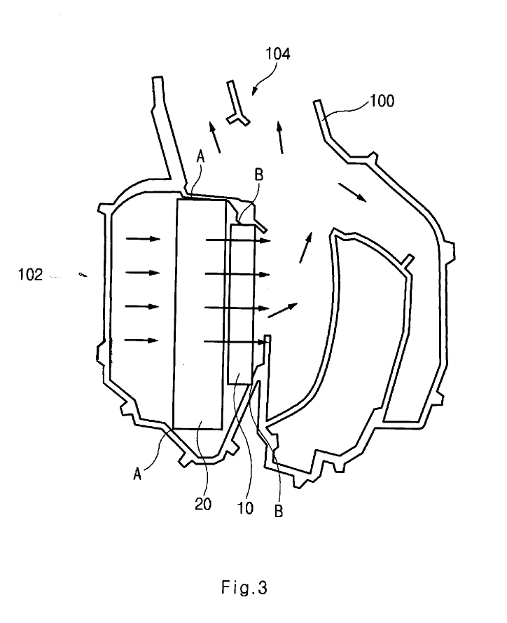

FIG. 3 is a side sectional view illustrating a configuration of the body 100 of the air conditioning system 1000 of the vehicle according to the present invention.

As illustrated in FIGS. 2 and 3, the body 100 is provided in the predetermined form, outside of which is sealed and inside of which provides an accommodation space. The inlet opening 102 through which the external air is supplied is positioned on one side of the body 100. At least one of the outlet opening 104 through which the hot air or the cold air is discharged from respective parts of the vehicle is positioned on the other side of the body. Here, the hot air or the cold air is generated by the electric heater core 10 or the cooling device 20 and is supplied through the inlet opening 102.

The body 100 includes a first coupling unit A and a second coupling unit B for respectively accommodating and coupling the cooling device 20 or the electric heater core 10, which will be described below. The cold air generated and discharged through an outlet opening 20b of the cooling device 20 passes through an inlet opening 10a and an outlet opening 10b of the electric heater core 10 and is outputted through the outlet opening 104 of the body 100. Meanwhile, the hot air discharged through the outlet opening 10b of the electric heater core 10 may be directly discharged to the outlet opening 104 of the body 100 without passing through the cooling device 20.

### Configuration of the Electric Heater Core 10

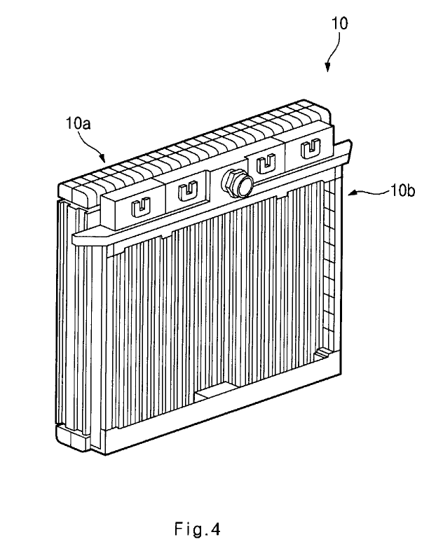

FIG. 4 is a perspective view illustrating the electric heater core 10 of the air conditioning system 1000 of a vehicle according to the present invention

As shown in FIG. 2 through FIG. 4, the electric heater core 10 is coupled to the first coupling unit A of the body 100 and includes the inlet opening 10a and outlet opening 10b. Preferably, the electric heater core 10 may be a positive temperature coefficient (PTC) heater, which heats a heating device by using electricity so that the heating device heats the air to generate the hot air. The more current the electric heater core 10 applies, the higher the temperature of the heating device becomes to generate the hot air of a higher temperature. The less current the electric heater core 10 applies, the lower the temperature of the heater becomes to generate the hot air of a relatively lower temperature. In addition, the control device 50 which will be further described below controls the amount of the current supplied to the electric heater core 10 to control the temperature of the hot air generated by the electric heater core 10.

### Configuration of the Air-Conditioning Unit 20

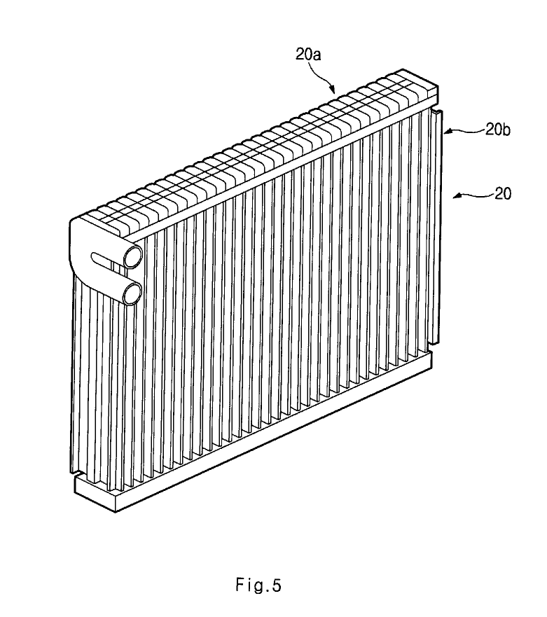

FIG. 5 is a perspective view illustrating the cooling device 20 of the air conditioning system 1000 of the vehicle according to the present invention

As shown in FIG. 2 through FIG. 5, the cooling device 20 is coupled to the second coupling unit B of the body 100 and includes an inlet opening 20a and the outlet opening 20b. As already known in the art, an air conditioner compressor includes a compressor that compresses a gaseous refrigerant to a high temperature, high pressure state by using, for example, an electric motor, a condenser in which a high temperature, high pressure gas outputted from the compressor is reacted with an inhaled external air, thereby turning into a liquid phase to generated heat, and an expansion valve in which a high pressure liquid outputted from the condenser is passed through a capillary tube to change to a lower pressure liquid. The evaporator connected with the expansion valve of the air conditioner compressor is used to evaporate a low temperature, low pressure liquid refrigerant outputted from the expansion valve by absorbing heat from a surrounding hot air, while discharging a cooled air, resulting from absorbing the hot air, through a fan. Namely, the evaporator of the cooling device 20 of the present invention is preferably connected to the first coupling unit A positioned within the body 100, wherein all of components thereof except for the evaporator are positioned outside of the body 100 to be connected with the evaporator. Here, it is described that only the evaporator of the cooling device 20 of the present invention is installed inside of the body 100; however, it should be noted that each of the components of the cooling device 20 can be alternatively designed to be installed inside the body 100.

The amount of gas evaporated by the evaporator is proportional to an amount of gas compressed by the air conditioner compressor. In other words, when a rotational speed (RPM) of the electric motor is increased, an increased amount of the refrigerant in the gaseous state can be compressed by the evaporator, thereby providing increased amount of the liquid refrigerant that is in a low temperature, low pressure state to the evaporator. To the contrary, when the rotational speed (RPM) of the electric motor is decreased, the amount of the refrigerant in the gaseous state that can be compressed by the evaporator is decreased, thereby providing reduced amount of the liquid refrigerant, which is in the low temperature, low pressure state, to the evaporator. Therefore, by controlling the rotational speed (RPM) of the electric motor of the evaporator, the amount of the refrigerant evaporated by the evaporator can be controlled, and accordingly, depending on the amount of the refrigerant evaporated, the temperature of the cold air generated by the evaporator can be controlled. For example, if the rotational speed of the compressor is 3000 RPM, the temperature of the cold air generated by the cooling device 20 may be 15.4° C. (59.7° F.), and if the rotational speed of the compressor is 5000 RPM, the temperature of the cold air generated by the cooling device 20 may be 11.8° C. (53.2° F.), and if the rotational speed of the compressor is 7000 RPM, the temperature of the cold air generated by the cooling device 20 may be 10.4° C. (50.7° F.). Here, the rotational speed of the electric motor can be controlled according to the amount of current applied to the compressor. Thus, by controlling the amount of the current applied to the compressor of the cooling device 20, the temperature of the cold air generated by the evaporator can be controlled.

### Configuration of the Sensor 30 and the Key Input Unit 40

As shown in FIG. 2, the sensor 30 includes a first sensor, a second sensor, a third sensor, etc.

The first sensor is installed inside the vehicle to measure the internal temperature of the vehicle.

The second sensor is installed outside of the vehicle to measure the external ambient temperature of the vehicle.

The third sensor is installed outside or inside of the vehicle to measure the intensity of sunlight.

The fourth sensor identifies a ventilation mode of the vehicle between an outer circulation mode and an internal circulation mode.

The key input unit 40 receives the target internal temperature from a user.

### Configuration of the Control Device 50

As shown in FIG. 2, the control unit 50 determines whether the ventilation mode of the vehicle is the outer circulation mode or the internal circulation mode by using the fourth sensor. In other words, if the vehicle is set to the outer circulation mode, an outside air and an inside air of the vehicle are circulated. In this case, the control unit 50 assumes in theory that the internal temperature of the vehicle is equal to the external ambient temperature of the vehicle and compare the external ambient temperature of the vehicle with the target temperature received through the key input unit 40 to control the internal temperature of the vehicle.

To the contrary, when the vehicle is set to the internal circulation mode, the outside air and the inside air are blocked to each other. In this case, the control unit 50 compares the internal temperature of the vehicle with the target temperature received through the key input unit 40 to control the internal temperature of the vehicle.

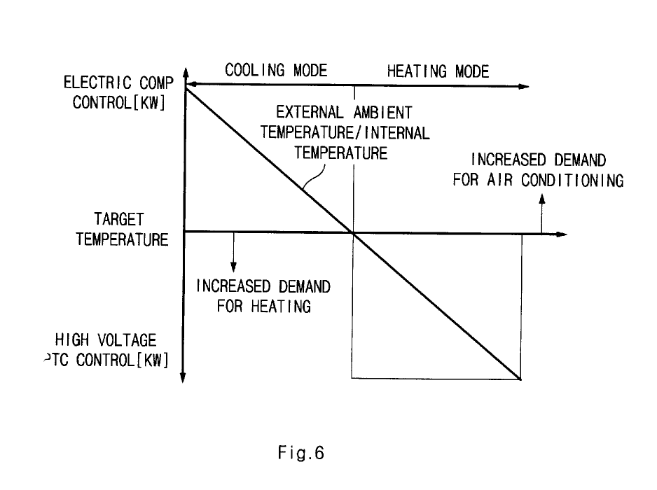

FIG. 6 is a graph showing a method of determining a heating mode or an air conditioning mode by comparing the target temperature with the external ambient temperature or the internal temperature in the control device 50 of the air conditioning system 1000 of the vehicle of the present invention.

As shown in FIG. 6, when the target temperature of the vehicle is 23° C. (73° F.) and the external ambient temperature or the internal temperature of the vehicle is 28° C. (82° F.), the external ambient temperature or the internal temperature of the vehicle is higher than the target temperature. In this circumstance, it is determined that the vehicle needs air conditioning so that the vehicle is switched to the air conditioning mode in which the electric heater core 10 is not operated and the cooling device 20 is independently operated.

To the contrary, when the target temperature of the vehicle is 23° C. (73° F.) and the external ambient temperature or the internal temperature of the vehicle is 13° C. (55° F.), the external ambient temperature or the internal temperature of the vehicle is lower than the target temperature. In this circumstance, it is determined that the vehicle needs to be heated so that the vehicle is switched to the heating mode in which the cooling device 20 is not operated and the electric heater core 10 is independently operated.

The control unit 50 of the vehicle controls the amount of current through the electric heater core 10 or the cooling device 20 depending on the difference between the external ambient temperature or the internal temperature and the target temperature, thereby precisely controlling the temperature of the hot air or the cold air respectively generated by the electric heater core 10 or the air conditioning device 20.

For example, the control unit 50 compares the target temperature of the vehicle with the external ambient temperature or the internal temperature. If the target temperature of the vehicle is 23° C. (73° F.) and the external ambient temperature or the internal temperature of the vehicle is 26° C. (79° F.), the external ambient temperature or the internal temperature of the vehicle is higher than the target temperature. In this case, it is determined that the vehicle needs air conditioning so that the electric heater core 10 is not operated and the cooling device 20 is independently operated until the external ambient temperature or the internal temperature reaches the target temperature.

To the contrary, if the target temperature of the vehicle is 23° C. (73° F.) and the external ambient temperature or the internal temperature of the vehicle is 15° C. (59° F.), the external ambient temperature or the internal temperature of the vehicle is lower than the target temperature. In this case, it is determined that the vehicle needs to be heated so that the air conditioning device is not operated and the electric heater core 10 is independently operated until the external ambient temperature or the internal temperature reaches the target temperature. Here, a technique to control the temperature of the hot air or the cold air generated by the electric heater core 10 and the cooling device 20 by controlling the amount of the current applied to the electric hard core 10 or the air conditioner device 20 will be described below in detail.

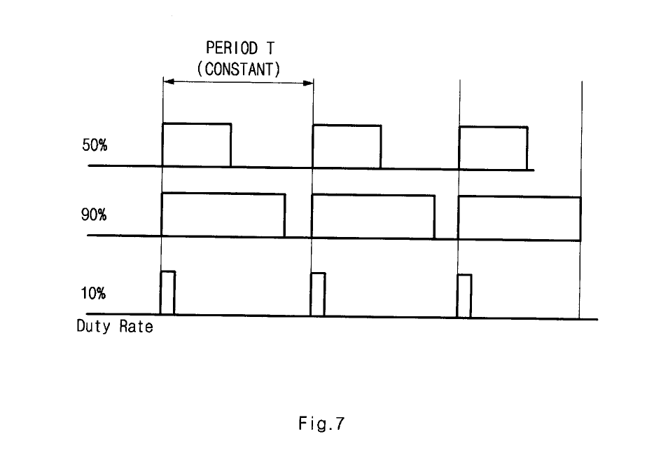

FIG. 7 is a graph showing a method of controlling an amount of a current to be supplied to the electric heater core 10 or the cooling device 20 through a duty rate control in the control device 50 of the air conditioning system 1000 of a vehicle of the present invention

As illustrated in FIG. 7, the control unit 50 linearly controls the amount of the current applied to the electric heater core 10 or the cooling device 20 by using pulse width modulation (PWM) of a DC pulse wave. The pulse width modulation of the DC pulse is a method to linearly control the amount of the current supplied to the electric heater core 10 or the cooling device 20 by controlling a width of the DC pulse wave. Here, when a value of the pulse width corresponds to “1,” an “ON” operation is performed to supply the current and, when the value of the pulse width corresponds to “0,” an “OFF” operation is performed to stop supplying current. Therefore, by controlling respective time periods during when the value of the pulse width corresponds to “1” and “0”, i.e., the duty rate (%), the amount of the current supplied to the heater core 10 or the cooling device 20 may be linearly controlled.

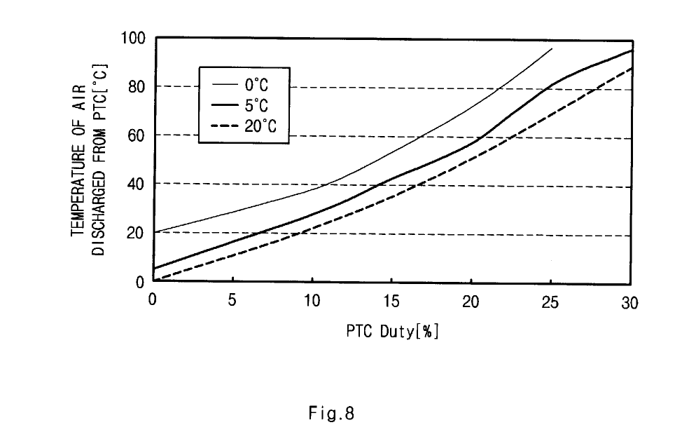

FIG. 8 is a graph showing a temperature of hot air generated by an electric heater core corresponding to a duty rate applied to the electric heater core according to the present invention, the duty rate varying depending on an external condition (external ambient temperature).

As shown in FIG. 8, the temperature of the hot air generated by the electric heater core 10 is linearly increased as the duty rate is increased.

The temperature of the hot air generated by the electric heater core 10 according to each amount of current or the temperature of the cold air generated by the cooling device 20 according to the each amount of current is stored in the database 60. For example, experimental data of temperature values of the hot air generated by the electric heater core 10 according to the each amount of current supplied thereto, i.e., duty rate, are stored in database 60. Also, an operational speed (RPM) of the compressor of the cooling device 20 is defined in the database 60 according to the amount of current supplied to the cooling device 20, i.e., the duty rate. Further, depending on the operating speed of the compressor, experimental data of temperature values of the cold air generated by the evaporator of the cooling device 20 are stored in the database 60 according to an operational speed of the evaporator. Here, when a difference between the internal temperature of the vehicle and the target temperature is greater, the control device 50 provides an increased amount of current to the electric heater core 10 or the cooling device 20. Accordingly, the electric heater core 10 or the cooling device 20 generates the hot air of a higher temperature or the cold air of a lower temperature. Consequently, the external ambient temperature or the internal temperature reaches the target temperature in a shorter time.

To the contrary, when the difference between the external ambient temperature or the internal temperature of the vehicle and the target temperature is smaller, the control device 50 provides a decreased amount of current to the electric heater core 10 or the cooling device 20. Accordingly, the electric heater core 10 or the cooling device 20 generates the hot air of a relatively lower temperature or the cold air of a relatively higher temperature. Even in this case, the external ambient temperature or the internal temperature of the vehicle can reach the target temperature in a shorter time. Thus, when the difference between the external ambient temperature or the internal temperature of the vehicle and the target temperature is smaller, the control unit 50 provides a smaller amount of current to the electric heater core 10 or the cooling device 20. Therefore, the air conditioning system 1000 of the vehicle according to the present invention may maximize energy efficiency. For example, when the difference between the external ambient temperature or the internal temperature of the vehicle and the target temperature is greater than 15° C. (59° F.), the control device 50 may provide a maximum current, e.g., 2 A to the electric heater core 10 or the cooling device 20. Meanwhile, when the difference between the external ambient temperature or the internal temperature of the vehicle and the target temperature is less than 5° C. (41° F.), the control device 50 may provide a minimum current, e.g., 500 mA to the electric heater core 10 or the cooling device 20. Meanwhile, when the difference between the external ambient temperature or the internal temperature and the target temperature is in a range of 5-14° C. (41-57° F.), the control device 50 may provide an intermediate level of current, e.g., 1 A.

Here, even if the external ambient temperature or the internal temperature of the vehicle reaches the target temperature, a driver may still feel hot when an intensity of sunlight that is irradiated into the vehicle is strong. To the contrary, when the intensity of sunlight irradiated into the vehicle is weak, for example, during a night time, the driver may feel cold even if the internal temperature reaches the target temperature. In this case, the control unit 50 compares the intensity of the sunlight measured by the third sensor with a preset reference value. If the intensity of the sunlight is higher than the reference value, the control device 50 corrects the target temperature to be lowered. If the intensity of the sunlight is lower than the reference value, the control device 50 corrects the target temperature to be increased.

An operation of the air conditioning system 1000 of the vehicle according to the present invention is described below.

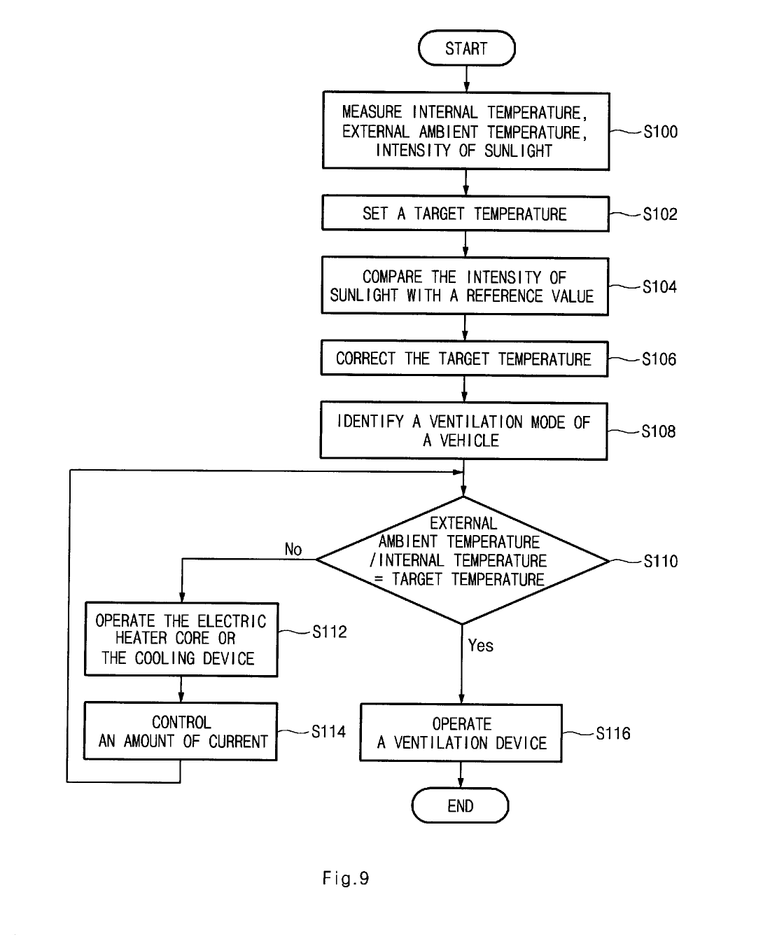

FIG. 9 is a flowchart illustrating an operation of the air conditioning system 1000 of the vehicle according to the present invention.

As shown in FIG. 9, the control unit 50 detects the internal temperature and the external ambient temperature of the vehicle, the intensity of the sunlight and the ventilation mode of the vehicle by using the first sensor, the second sensor, the third sensor and the fourth sensor (S100).

Next, the control unit 50 receives the target internal temperature of the vehicle from the user through the key input unit 40 (S102).

Then, the control unit 50 compares the intensity of the sunlight with the preset reference value (S104).

Next, if the sunlight intensity is higher than the preset reference value, the control unit 50 corrects the target temperature to be lowered and, if the solar intensity is lower than the preset reference value, the control unit 50 corrects the target temperature to be increased (S106).

The control unit 50 identifies the external ambient temperature or the internal temperature of the vehicle, which is to be compared with the target temperature, based on the ventilation mode of the vehicle (S108)

The control unit 50 compares the external ambient temperature or the internal temperature with the corrected target temperature (S110).

Next, if the corrected target temperature is lower than the external ambient temperature or the internal temperature, the control unit 50 switches to the heating mode to independently operate the electric heater core 10, and if the corrected target temperature is higher than the external ambient temperature or the internal temperature, the control unit 50 switches to the air conditioning mode to independently operate the cooling device 20 (S112).

Then, depending on a difference between the corrected target temperature and the external ambient temperature or the internal temperature, the control unit 50 controls the amount of the current applied to the electric heater core 10 or a cooling device 20 to control the temperature of the hot air or the cold air generated by the electric heater core 10 or the cooling device 20 (S114).

Next, if the corrected target temperature is equal to the external ambient temperature or the internal temperature, the control unit 50 stops operating the electric heater core 10 or the cooling device 20 and switches to the ventilation mode to operate a ventilation device of the vehicle (S116).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air conditioning system of a vehicle, the system comprising:
a body;
an electric heater core installed within the body and configured to generate a hot air;
a cooling device installed within the body and configured to generate a cold air; and
a control device configured to control a temperature of the hot air generated by the electric heater core and/or a temperature of the cold air generated by the cooling device, respectively, by controlling an amount of current applied to the electric heater core and/or the cooling device according to a difference between an internal temperature or an external ambient temperature of the vehicle and a target temperature, the electric heater core and the cooling device being operated independently of each other.

2. The system according to claim 1, wherein the body includes an inlet opening positioned on a first side thereof through which an air is supplied from an external and a discharge opening positioned on a second side thereof through which the air supplied through the inlet opening is discharged to an internal space of the vehicle,
wherein an inlet opening of the cooling device is positioned facing opposite to the inlet opening of the body, and
wherein an inlet opening of the electric heater core is spaced apart from an outlet opening of the cooling device at a predetermined distance to be positioned facing opposite to the outlet opening of the cooling device, and
wherein the cold air provided from the outlet opening of the cooling device passes through the inlet opening and an outlet opening of the electric heater core to be discharged from the discharge opening of the body.

3. The system according to claim 1, further comprising:
a first sensor configured to measure the internal temperature of the vehicle;
a second sensor configured to measure the external ambient temperature of the vehicle;
a key input unit configured to receive the target temperature; and
a database configured to store the temperature of the hot air generated by the electric heater core according to each amount of the current or the temperature of the cold air generated by the cooling device according to the each amount of the current, wherein the control device turns to an air conditioning mode to independently operate the cooling device when the external ambient temperature or the internal temperature of the vehicle is higher than the target temperature, and wherein the control device turns to a heating mode to independently operate the heating device when the external ambient temperature or the internal temperature of the vehicle is lower than the target temperature.

4. The system according to claim 1, further comprising a third sensor configured to measure an intensity of sunlight irradiated into the vehicle, wherein the control device corrects the target temperature based on the intensity of the sunlight.

5. The system according to claim 1, wherein the control device linearly controls the amount of the current applied to the electric heater core or the cooling device using a pulse width modulation of a DC pulse wave.

6. The system according to claim 1, further comprising a fourth sensor configured to identify a ventilation mode of the vehicle, wherein, when the ventilation mode of the vehicle is an outer circulation mode, the external ambient temperature is compared with the target temperature to control the temperature of the hot air generated by the electric heater core or the temperature of the cold air generated by the cooling device and, when the ventilation mode is an internal circulation mode, the internal temperature is compared with the target temperature to control the temperature of the hot air generated by the electric heater core or the temperature of the cold air generated by the cooling device.
